(19) United States
(12) Patent Application Publication
(10) Pub. No.: US 2006/0176843 A1
(43) Pub. Date: Aug. 10, 2006

(54) Method and apparatus for providing low bit rate satellite television to moving vehicles

(76) Inventors: Yoel Gat, Airport City (IL); Mario Ganchev Gachev, Sofia (BG); Gueorgui Angelov Prandjev, Volingrad (BG)

Correspondence Address: SUGHRUE MION, PLLC, 2100 PENNSYLVANIA AVENUE, N.W., SUITE 800, WASHINGTON, DC, 20037, US

(21) Appl. No.: 11/074,754

(22) Filed: Mar. 9, 2005

Related U.S. Application Data
(60) Provisional application No. 60/650,122, filed on Feb. 7, 2005.

(51) Int. Cl. H04B 7/185

(52) U.S. Cl. 370/316

(57) ABSTRACT

A method and apparatus for providing satellite television and other data services to moving vehicles. In the method of the invention, substantially the full power of the transponder of a satellite, normally associated with bit rates of more than 30-40 Mbps, is reduced to a lower bit rate, for example, 1-2 Mbps, associated with between one and six video channels. As such, more power is provided per channel, allowing easier reception by small aperture antennas used on or in the moving vehicles.

### FIELD OF THE INVENTION

The present invention relates to a method and apparatus for providing satellite television to moving vehicles using dedicated services through geostationary satellite transponders typically operating at the Ku or Ka bands.

More particularly, the present invention relates to a method and apparatus wherein substantially all power of the transponder of a satellite, normally associated with bit rates of more than 30-40 Mbps, is concentrated on providing a lower bit rate, for example, 1-4 Mbps, associated with between one and six video channels. Accordingly, more power is provided per channel, allowing easier reception by small aperture antennas used on or in the moving vehicles.

### DESCRIPTION OF THE RELATED ART

Providing a combination of television and data services via satellite is known in the related art. Several companies in the world provide the satellite market with different kinds of antenna terminals that serve either or both television reception and data communications. All of these antenna terminals use an existing service for broadcasting and data communications provided by repeaters (transponders) installed on satellites arranged on the geostationary orbit, which is optimized for fixed stationary subscriber terminals installed in a given geographical earth location. These antennas are physically large, with antenna apertures in the range of 50 to 80 cm in diameter, and are not suitable for mobile applications in the Ku and Ka bands, particularly for vehicles such as trucks, trains, boats, busses, cars and the like.

For example, a direct broadcast satellite (DBS) system uses Ku-band satellites that send digitally-compressed television and audio signals to fixed and stationary satellite dishes. DBS systems transmit signals to Earth in a Broadcast Satellite Service (BSS) portion of the Ku band between 12.2 and 12.7 GHz. The DBS system incorporates digital compression to deliver numerous programming channels to the fixed stationary subscriber terminals.

For mobile applications, receiving antennas designed to be mounted on moving vehicles and having a low height profile must generally have a larger size compared with stationary terminals in order to compensate for performance degradation connected with satellite pointing and signal tracking. For mobile users, the terminal height is of great importance, and a preferable shape of the antenna is a panel with a very low height of no more than a few inches lying flat on a vehicle roof or even recessed inside the roof or body. For purposes of description, a “vehicle” as referred to herein should be understood as a representative vehicle and does not limit the applicability of the invention. For example, the vehicle could include an automobile, bus, train, boat, and even an aircraft.

However, this type of low profile antenna, for example, one that is optimally flat on the car roof, means that less effective area of the antenna is seen from a satellite position at a given elevation angle. This in turn requires an additional increase of the antenna's horizontal dimensions. However, the increased area adds complexity and cost to the antenna. Further, the installation of such an antenna is cumbersome. Moreover, from a design standpoint, it is difficult to provide a profile that is aesthetically pleasing.

Further, the flat mobile antenna terminals in the related art, which are able to support existing broadband satellite service, such as the DBS system, are relatively complicated and expensive. Additionally, the solutions for in-motion or mobile satellite TV terminals that have been offered to date, for example, terminals such as the RaySat SpeedRay 1000 or the KVH TrackVision A5 are not particularly suited for low-cost mass produced original equipment manufacture (OEM) products that should either be embedded in the vehicle roof or of such low height profile that they can be placed unobtrusively atop a vehicle roof.

Thus, one aspect of the invention is to provide a method and apparatus including antennas, a transmission system, and receivers, for mobile satellite communication, supporting dedicated transponder-based services in the Ku and Ka bands, with vehicle terminals that are flat, smaller in size, and lower in cost and could be readily embedded in or unobtrusively placed on the vehicle roof or the vehicle body.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome all or even any of the problems described above.

The present invention provides a method and apparatus for providing satellite television to moving vehicles. A satellite service as used in exemplary embodiments of the invention, while available to many kinds of users, is dedicated to mobile users and incorporates a transmission system, and a satellite system that is operable in the Ku and Ka bands, and incorporates digital compression techniques and effective use of satellite modulation, transponder bandwidth, and power to permit broadcast quality video to mobile terminals that are smaller and more economical than previously practical.

While the exemplary embodiments described herein are focused on satellite television, the invention is not limited thereby. For example, other entertainment and data services known in the art may be used. Of course, the present invention is also capable of working in the S band, although this aspect of the invention is not the focus herein when describing the best mode.

In an exemplary embodiment of the invention, a video compression standard is used such as MPEG-2, which allows NTSC-quality video to be encoded into an information bit stream of about 3-6 Mbps. Here, about 12 NTSC TV programs may be multiplexed and sent over a typical DBS 27 MHz transponder.

A relatively new compression standard, MPEG-4 has the potential to significantly decrease the required information bit rate for each TV program, providing more than a 2:1 reduction, while maintaining relatively high quality. Other compression methods, such as Microsoft Windows Media 9 may also offer reductions in information rate for a given broadcast quality.

The information rate (typically defined in megabits per second or Mbps) in the satellite transmission link for a given channel of video is an important parameter when considering the effect and operation of the present invention. For a given value of the equivalent isotropically radiated power (EIRP) from the satellite, a lower information rate requires less antenna gain-to-noise temperature (G/T) at the receiving terminal and therefore, less antenna capture area or smaller antenna aperture. Accordingly, from a system perspective, according to a method of this invention, in an exemplary embodiment, the source program material is encoded with a compression algorithm and uplinked to the satellite, which allocates substantially the full power of a DBS transponder, normally associated with bit rates of more than 30-40 Mbps, to a lower bit rate, for example, 1-4 Mbps, and associates that lower bit rate to a small number of video channels. In one exemplary embodiment, between 1 and 6 broadcast quality TV channels are accommodated per transponder, with the aggregate bit rate for the channels being 1-4 Mbps and each channel being allocated an appropriate share of the total available power of the transponder, as would be understood by one skilled in the art.

In this manner, the high EIRP and relatively low bit rate permit adequate reception from terminals that are significantly smaller (and more economical to manufacture) than terminals used in related art in-motion systems. Also, consistent with a digital video broadcast (DVB) standard, ready identification of the proper satellite by the tracking receiving terminal can be achieved. The DVB standard that can be adapted for use with the present invention may be, in an exemplary embodiment, DVB-S2. The DVB-S2 standard includes techniques such as adaptive coding to maximize the usage of transponder resources. DVB-S2 also encompasses the 3 modulation modes: QPSK, 8PSK, and 32APSK. The DVB-S2 standard, ETSI EN 302 307 V1.1.1 (2004-06) is in draft form as of the filing of this application and may be accessed at http//www.dvb.org.

To spread the signals, another method such as Code Division Multiple Access (CDMA) may be used in the invention. CDMA is used for spread-spectrum data distribution. Transmissions being spread spectrum encoded with spreading code lengths may be selected to provide adequate data recovery at small-sized terminals of the invention. Implementation of the CDMA methodology can be seen, for example, in U.S. Pat. No. 4,455,651 to Baran. The '651 patent was assigned to Equatorial Communications Company, and substantially implemented in their product, the Equitorial C100.

In the present invention, spread spectrum modulation techniques enables the signal to be transmitted across a frequency band that is much wider than the bandwidth required by the information signal (for example, 1 MHz to 20 MHz).

In another exemplary embodiment, cost efficient, inclined-orbit satellites, for example, those satellites that have reached their “end-of-life” as defined by criteria including the lack of supply of the satellites' station-keeping fuel that allows them be kept in precise orbital locations, are used. Such satellites may still have useful transponder bandwidth and power provided by solar energy collectors, but are moved from a geostationary orbit (minimum orbital separation of 2 degrees with positional accuracy of 0.1 degrees) to an inclined orbit where the satellite is allowed to drift in the north/south plane with the result that they move slowly as seen from the earth, for example, at ±0.8 degrees per year. While such motion is a problem for stationary fixed-pointing antennas, they are easily accommodated by mobile tracking antennas with a beam width of 15-20 degrees. Placing dedicated, specialized mobile services such as described herein on these satellites can ensure effective video service (as well as audio and data, if desired) to smaller mobile terminals than would otherwise be required for traditional satellite broadcast and thereby make such services available for a large number of mobile users.

For specific transmission systems and video parameters, a subscriber antenna supporting this service in Ku band, may be a low profile antenna and have a size in one planar dimension of less than about 40 cm (e.g., area of less than 1600 cm²) and a thickness less than about 3 cm compared with much larger mobile terminals required for related art DBS transmissions. The aperture of the antenna would be well below the conventional 50-80 cm used on current mobile antennas, preferably in the range of 20-40 cm, and more preferably in the range of under 20 cm.

Several embodiments of a low profile antenna useable with the present invention are possible and are not limited to the examples described herein. A first exemplary embodiment of the antenna includes a Fully Electronically Scanning Antenna (FESA), which comprises phase controlling devices integrated in a low profile antenna package to control the phases of the array antenna element and to steer the antenna beam electronically in all directions. A downconverter unit is integrated into the antenna package together with a control and interface unit, which provides control of the phase controlling elements to point the antenna beam properly toward the selected satellite. It is also practical to integrate the receiver (set-top-box or STB) in an outdoor unit (ODU).

The ODU, which includes a terminal on or embedded in the roof of a vehicle, may have a cable, or even a wireless, interface to multimedia and/or audio and video display devices. The data needed for proper beam pointing and DC power supply may (though not necessarily) be provided by the vehicle navigation system (which may use GPS or other navigation-capable satellites) and the vehicle power supply unit through the said interface and control unit. Alternatively, a separate pointing system may be provided.

In another embodiment of the invention, there is a Fixed Beam in elevation Mechanical scan in Azimuth antenna (FBMA), which may be simpler and lower in cost compared with FESA, but with lower performance and perhaps a slightly greater height, but still low profile. Here, the beam is initially tilted toward the middle of the elevation field of view and steered mechanically in azimuth using a low profile motor. The beam is designed to be wide enough in the elevation plane to cover the required field of view, which is based on the geographical locations of the coverage area and the satellite's position in orbit.

In this case, the antenna package, including a downconverter, receiver and control and interface circuit may be arranged on a rotating platform. In the examples herein, the downconverter may be a low noise block downconverter (LNB) as commonly used in the art, the DC connection may be a rotary joint, and the signals may be processed by receivers known in the art. Of course, the signal connection between the interface and control circuit and the equipment in the vehicle may also be wireless.

The data for beam pointing may be provided by a devices such as related art Global Positioning System (GPS) devices and/or electronic compasses. Also, the vehicle's navigation system may be used to allow information from the car's on board navigation system to be used by the antenna beam controller to track the selected satellite.

Yet another exemplary embodiment includes a Semi-electronic Scan in Elevation with Mechanical Scan in Azimuth Antenna (SEMA). Here, the beam steering in azimuth may be again mechanical, but elevation beam positions may be generated electronically, either continuously with phase shift and/or time delay devices or by selection among a number of fixed beams positions such as could be provided by known techniques for realizing a multiple-beam beam forming network (BFN).

Each such beam would have a higher gain than a single broad elevation beam and the performance of the antenna may be better than that of the corresponding FBMA or, it could allow a smaller antenna for the same performance. Since the beam steering, or scanning, is performed in one plane only it is possible to arrange corresponding antenna elements in rows and to control the phase of the entire row in the process of scanning. This may reduce significantly the number of phase controlling devices, significantly reducing complexity and cost compared with the FESA.

Other possible low profile antenna embodiments may be used, such as arrays with leaky waveguide elements, antennas using variable inclination continuous transverse stub technology, arrays with radial waveguide distribution circuits, planar arrays and even specially shaped reflectors. For example, the principles of operation and construction of a multi-array or multi-panel antenna receive system are disclosed in the patent application U.S. Ser. No. 10/752,088 Mobile Antenna System for Satellite Communications, the disclosure of which is incorporated herein by reference.

A receiver, as used in the invention, may be embodied as a functional equivalent of a “set-top-box” (STB), and could be integrated with the antenna terminal as part of the ODU, or it could be a separate module inside the car as part of an indoor unit (IDU). The receiver system may incorporate equipment and software for the latest transmission standards, such as the DVB-S2 chip set, or could incorporate a spread spectrum receiver. The transmission system and receiver may also incorporate decoders for use of highly effective source material compression to maintain high video quality with relatively low transmission data rates. Examples of compressions standards include MPEG-4 v10 and Microsoft Windows Media 9.

### BRIEF DESCRIPTION OF THE DRAWINGS

The above and other features and advantages of the present invention will become more apparent by describing in detail exemplary embodiments thereof with reference to the attached drawings in which:

FIG. 1 schematically illustrates a method and system for providing television and other data to the moving vehicles according to an exemplary embodiment of the invention.

FIG. 2A illustrates providing signals on an uplink side, where the signals are processed using a spread spectrum spreader, and FIG. 2B represents a receive site for receiving the signals that includes a de-spreader.

FIG. 3 illustrates the block diagram of a Full Electronically Scanning Antenna according to an exemplary embodiment of the invention

FIG. 4 illustrates the structure of the Full Electronically Scanning Antenna according to an exemplary embodiment of the invention

FIG. 5 illustrates the block diagram of a Fixed Beam in Elevation Mechanical Scan in Azimuth Antenna according to an exemplary embodiment of the invention

FIG. 6 illustrates the structure of the Fixed Beam in Elevation Mechanical Scan in Azimuth Antenna according to an exemplary embodiment of the invention.

FIGS. 7A and 7B illustrate the beam pointing technique used in the Fixed beam in Elevation Mechanical Scan in Azimuth Antenna according to an exemplary embodiment of the invention.

FIG. 8 illustrates the block diagram of the Semi-electronic Scan in Elevation Mechanical Scan in Azimuth Antenna according to an exemplary embodiment of the invention.

FIG. 9 illustrates the structure of the Semi-electronic Scan in Elevation Mechanical Scan in Azimuth Antenna according to an exemplary embodiment of the invention.

FIG. 10 illustrates the beam pointing technique used in the Semi-electronic Scan in Elevation Mechanical Scan in Azimuth Antenna according to an exemplary embodiment of the invention.

FIGS. 11A-11C illustrate the functionality of specific variants of the apparatus according with the embodiment of the invention.

### DETAILED DESCRIPTION OF EXEMPLARY EMBODIMENTS OF THE INVENTION

Hereinafter, exemplary but non-limiting embodiments of the present invention will be described in detail with reference to the accompanying drawings.

The present invention relates to a satellite TV and data service, provided for use in the Ka and Ku bands, aimed for vehicles including aftermarket & OEM. As noted above, according to the invention, all or substantially all of the full power of the transponder of a satellite, normally associated with bit rates of more than 30-40 Mbps, is allocated to the provision of signals at a lower bit rate, for example, 1-2 Mbps, associated with between one and six video channels, wherein more power is provided per channel, allowing easier reception by small aperture antennas used on or in the moving vehicles.

While transmission on a downlink at 1-2 Mbps rate is suggested for the present exemplary embodiment, the rate may extend to 4 Mbps or even above, while utilizing the inventive concept disclosed herein. Further, while it is contemplated that all of the available power of a given satellite transponder will be dedicated to the low bit rate transmissions on only a few downlink channels, it is within the scope of the invention to have a substantial amount, but less than all of the full power utilized. One skilled in the art would recognize that a partial use would give rise to inefficiencies that would mitigate against adoption of the invention in a commercially attractive system.

The invention, in exemplary embodiments, contemplates the use of a small antenna, for example, one having an array area less than about 1600 cm². As one example, but without limitation to shape or size, a circular planar antenna of about 20-40 cm diameter ×about 2.5-3 cm high may be used. The antenna is able to support a dedicated cost-efficient service provided by transponders, either kept in geostationary orbit or, if appropriate, in an inclined orbit, such as would be used for end-of-life DTH satellites. The lower cost of service provided by the end-of-life satellites, allows for 1-6 TV channels per transponder, still ensuring cost-effective service, giving due consideration to the great number of customers that may be served by such system.

The aforementioned approach reduces dramatically the required antenna gain of the terminals installed in or on the user's vehicle. In this manner, the small flat antenna may provide a mass market consumer item that can be mass produced and embedded in the car roof as an OEM product.

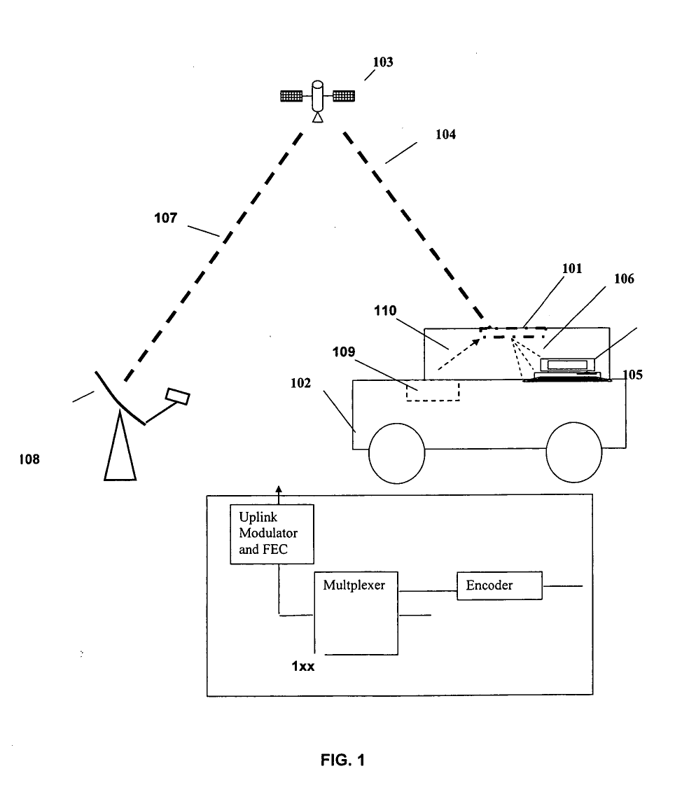

A first exemplary embodiment is depicted in FIG. 1. In FIG. 1, antenna terminal 101, embedded in the roof of a moving vehicle 102 receives dedicated service signals 104, which may be, for example, MPEG-4 coded or coded using another advanced coding system prior to being uplinked to the satellite 103, and processed properly in order to accommodate, for example, 1-6 channels per transponder, provided by an uplink facility (earth station) 108 using uplink 107 to a satellite.

As noted above, in an exemplary embodiment, the satellite may be, for example, a satellite in an inclined geosynchronous orbit, such as an end-of-life (EOL) satellite.

A media device (TV display, audio system, computer, navigation system, etc.) 105 may be connected, either wired or wirelessly 106 with the antenna terminal 101. The information needed to control the antenna system beam is provided by the car navigation system 109, using a wired or wireless connection 110 to the control and interface circuit, integrated in the antenna terminal 101.

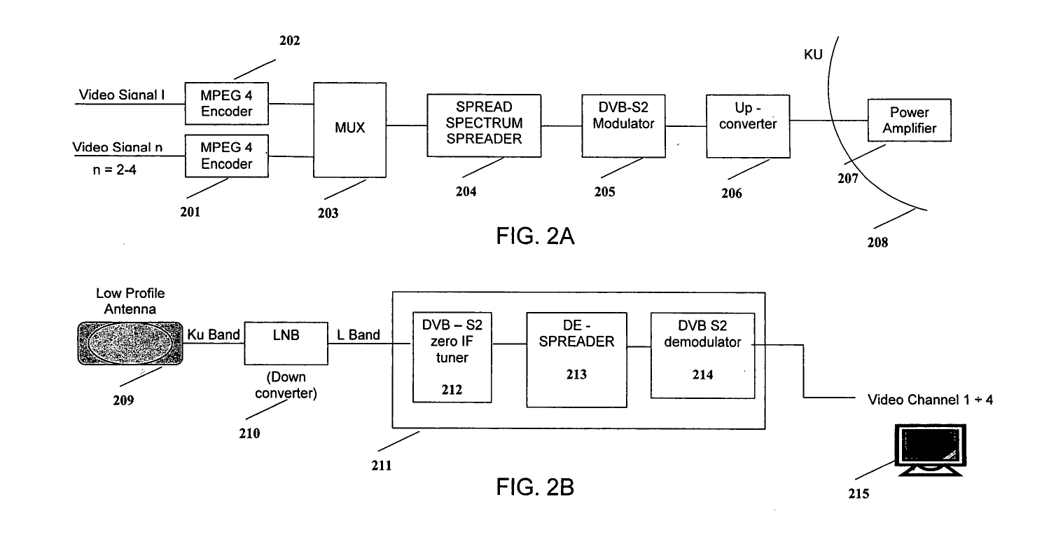

An example of using CDMA spread-spectrum techniques according to the invention is shown in FIGS. 2A and 2B. In FIG. 2A, video signals (l . . . n) are encoded at MPEG-4 Encoders 201 and 202 from where they are sent to Multiplexer 203. Multiplexer 203 combines the signals for transmission over one communications channel. Subsequently, the multiplexed signal is sent to Spread Spectrum Spreader 204. Spread Spectrum Spreader 204 spreads the signal bandwidth over a wide range of frequencies for transmission. A DVB-S2 Modulator 205 combines the signal with a carrier signal for distribution through Up-Converter 206 which provides frequency conversion to a higher frequency. The use of MPEG-4 compliant compression and DVB-S2 compliant transmission schemes in the present invention generally results in about a three-fold improvement in satellite transponder utilization than when using MPEG-2 and DVB-S standards.

The up-converted signals are then amplified by Power Amplifier 207 included in antenna 208 for transmission to a satellite (not shown).

For each channel the energy per bit at the satellite must be high enough to accommodate the worst case antenna. Further, the energy from each carrier must reside within a given satellite channel.

As shown in FIG. 2B, signals are received at Low-Profile Antenna 209 and down-converted by LNB 210. The signals are processed by Receiver 211 which includes a DVB-S2 zero IF tuner 212, a De-Spreader 213, and a DVB-S2 demodulator 214 for essentially reversing the processing on the uplink side as discussed with relation to FIG. 2A. In this embodiment, up to four video channels are output to television monitor 215.

An antenna used in connection with the present invention may include any of several exemplary embodiments, but the antennas would have apertures well below the conventional 50-80 cm used on current mobile antennas, preferably in the range of 20-40 cm, and more preferably in the range of 20 cm and under.

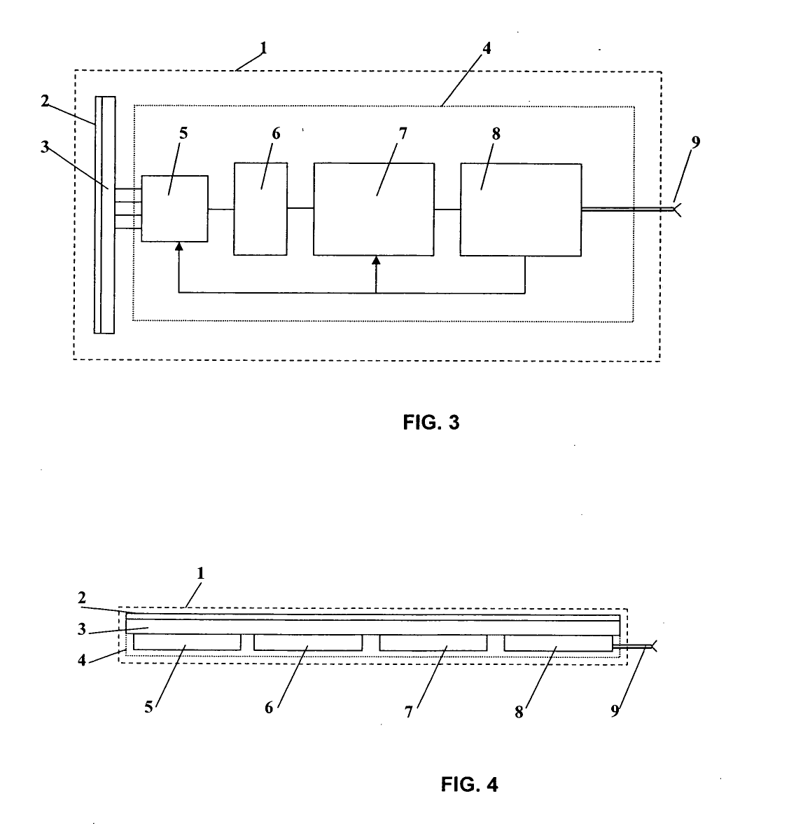

One possible embodiment, a Full Electronically Scanning Antenna (FESA), is shown in FIG. 3. The FESA comprises a housing 1, an antenna radome 2, an array elements layer 3, and antenna electronic layer 4. Antenna electronic layer 4 comprises microwave active components such as Low Noise Amplifiers (LNA) and Phase or time delay Controlling Devices (PCD) 5, downconverter 6, receiver/decoder 7, which in one exemplary embodiment may be integrated into the antenna or, in another embodiment, installed inside the vehicle, a universal interface and control circuit 8, and an interface connection 9 with the multimedia equipment inside vehicle. The active components 5 are used to control in a proper way the phases of the signals received by antenna elements arranged on the antenna elements layer 3 in order to point the antenna beam in the direction toward a selected satellite.

The received signal is transferred to the downconverter 6 and then to the integrated receiver 7. The interface between the integrated receiver 7 and the multi-media equipment inside the vehicle comprises interface and control circuit 8 supporting audio, video and data interface options, and an interface connection 9. Interface connection 9 may be a coaxial cable or wireless connection between the interface circuit 8 and the equipment inside vehicle and a DC cable for the antenna power supply. Interface connection 9 also provides user remote control commands to the said integrated receiver 7.

An exemplary embodiment of the FESA structure is shown in FIG. 4. Like elements included in the Figures that follow include the same item numbers for ease of understanding.

The FESA structure may be a multi-layer package of a proper set of PWB (Printed Wire Boards) or LTCC (Low Temperature Cofired Ceramic) layers arranged properly in the antenna housing 1, which may be a part of the vehicle construction. The package comprises a radome 2, antenna element layer 3 and antenna electronic layer 4, arranged on the bottom side of the package, which comprises LNAs and PCDs 5, downconverter circuit 6, and receiver 7, which in one preferred embodiment may be integrated into antenna and interface circuit 8.

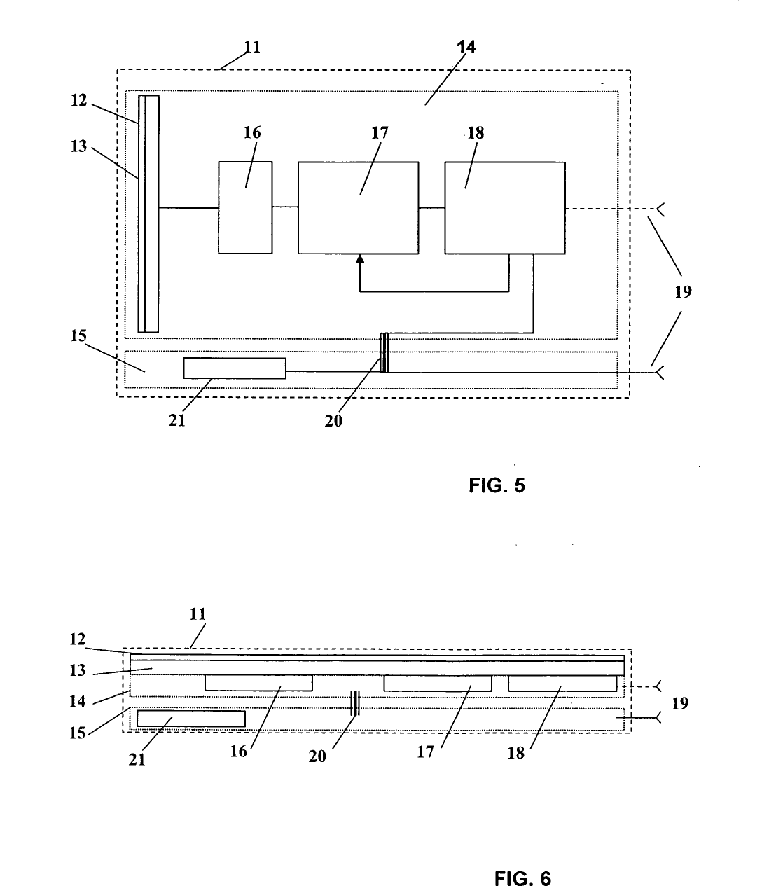

Another antenna embodiment of the invention is a Fixed Beam in elevation Mechanical scan in Azimuth antenna (FBMA). A FMBA is shown in FIG. 5.

The FBMA comprises antenna housing 11, radome 12, antenna elements layer 13, rotation platform 14, stationary platform 15, downconverter 16, receiver/decoder 17 which in one preferable embodiment may be integrated into antenna, interface and control circuit 18, interface connection 19, DC rotary joint 20 and azimuth motor and driver 21.

An exemplary construction of a FBMA is shown in FIG. 6. In FIG. 6, the Antenna package is arranged on the rotary platform 14, which when rotated, will point the beam in the desired azimuth direction toward the selected satellite. On the bottom side of the antenna package, a downconverter 16, an integrated receiver 17 and interface and control circuit 18 are mounted. The stationary platform 15 comprises azimuth motor and driver 21 and a DC rotary joint 20 that carries the needed DC supply for the devices arranged on the rotary platform.

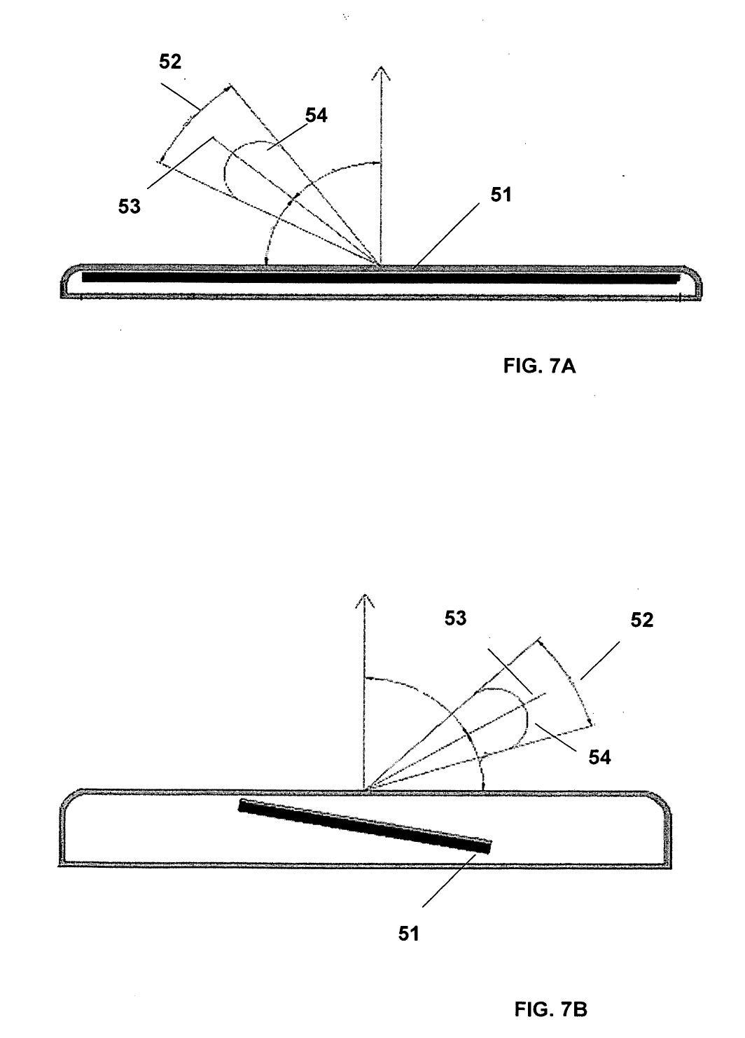

The beam pointing technique used with the FMBA is illustrated in FIGS. 7A and 7B. In one exemplary embodiment, the antenna panel 51 stays flat over the car roof, ensuring a lowest possible profile of the antenna FIG. 7A. In another possible embodiment a tilted panel 51 is used in order to cover lower elevation angles as shown in FIG. 7B. To cover the required field of view in elevation 52, the antenna panel 51 is designed to generate a broad elevation plane antenna beam 54 initially tilted toward a direction pointing in the middle of the required field of view in the elevation plane 53.

The initial tilt 53 is achieved by using appropriate delay lines in the combining circuits feeding the array antenna elements, as would be understood by one skilled in the art.

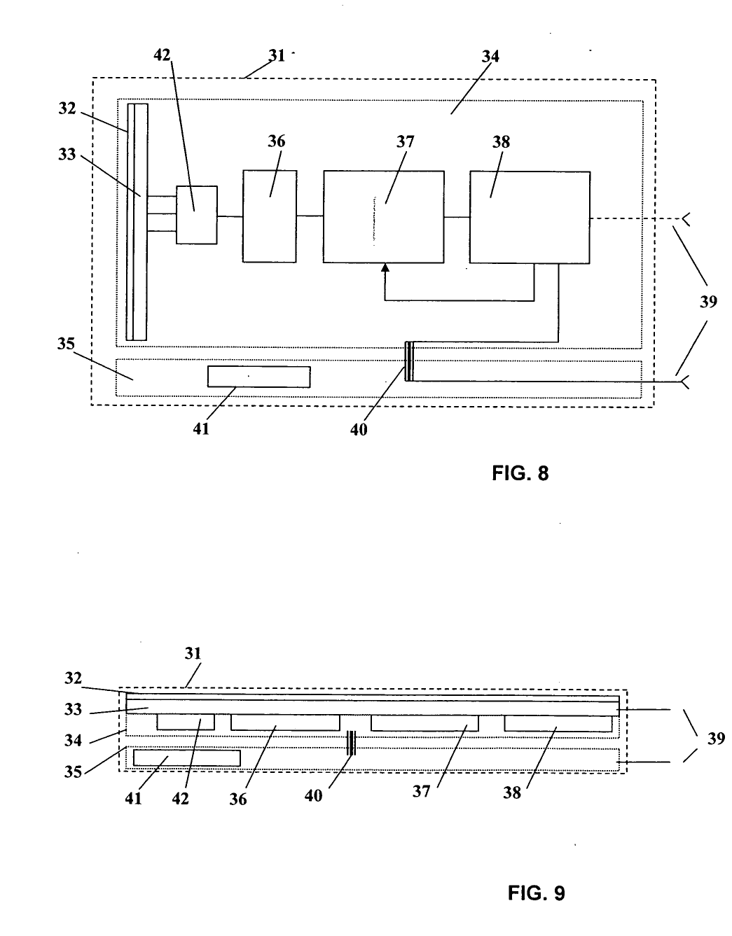

Another antenna embodiment includes a Semi-electronic scan in Elevation Mechanical scan in Azimuth Antenna (SEMA). A SEMA of the invention is shown in FIG. 8.

The SEMA antenna embodiment comprises antenna housing 31, radome 32, antenna elements layer 33, rotation platform 34, stationary platform 35, downconverter 36, receiver/decoder 37, which in one preferable embodiment may be integrated into antenna, interface and control circuit 38, interface connection 39, DC rotary joint 40, azimuth motor and driver 41, and low-noise amplifiers LNA and Phase controlling devices PCDs 42.

One exemplary construction of a SEMA is shown in FIG. 9. The antenna package is arranged on the rotary platform 34, which rotating may point the beam in the desired azimuth direction toward the selected satellite. On the bottom side of the antenna package LNAs and PCDs 42 are mounted in order to control the beam in elevation, a downconverter 36, an integrated receiver 37 and interface and control circuit 38 are mounted. The stationary platform 15 comprises azimuth motor and driver 41 and a proper DC rotary joint 40 carrying the needed DC supply for the devices arranged on the rotary platform.

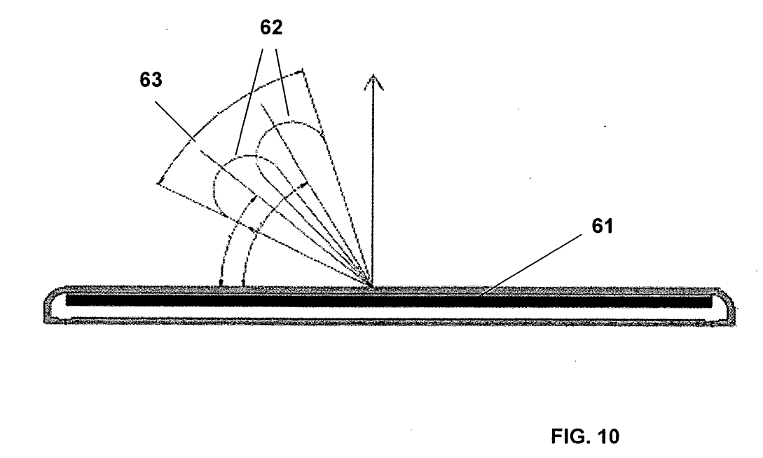

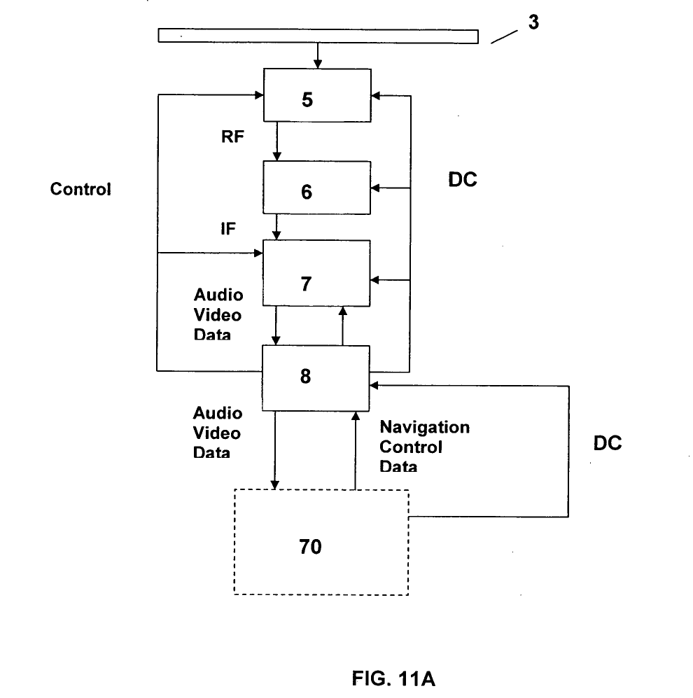

A beam pointing technique used in the SEMA antenna is illustrated in FIG. 10. An antenna beam is steered in the azimuth plane mechanically, rotating the antenna panel 61 using the azimuth motor 41 while a steerable beam 62 in the elevation plane is generated electronically by controlling the antenna element phases using the PCDs 42 mounted on the bottom side of the antenna panel 61. The elevation range of the beam is selected in order to cover the required field of view 63 in elevation.

Other embodiments may be used, such as arrays with leaky waveguide elements, antennas using variable inclination continuous transverse stub technology, arrays with radial waveguide distribution circuits, planar arrays and even specially shaped reflectors.

The receiver integrated in the antenna terminals, which exemplary variants are described above, may be, for example, a simple set top box (STB) built using a standard DVB-S2 chip set or a simple spread spectrum receiver, either connected with an integrated MPEG-4 (or other efficient compression standard) decoder.

The interface and control circuit may be integrated also at the bottom side of the antenna package and ensures universal audio, video and data interface with the equipment installed in the vehicle, and at the same time controls the antenna beam in order to be pointed all the time toward the selected satellite using the information provided by the car's navigation system.

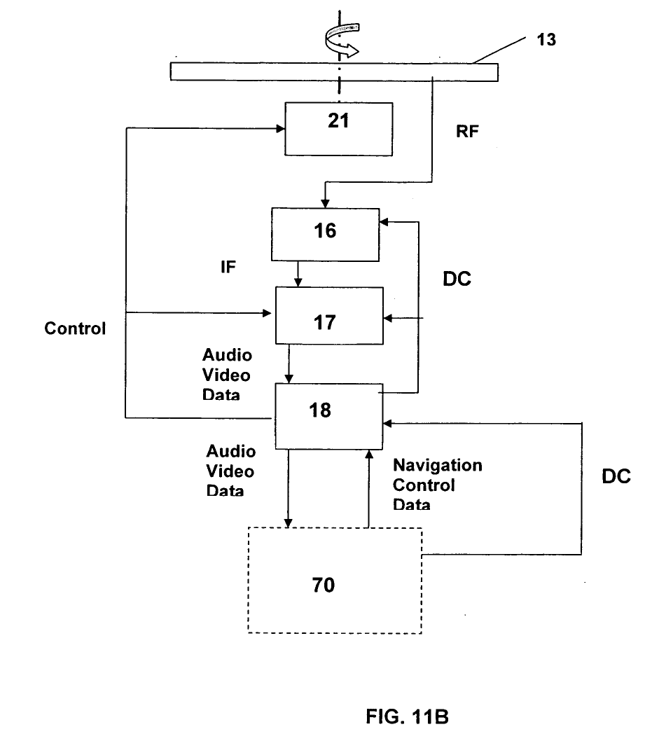

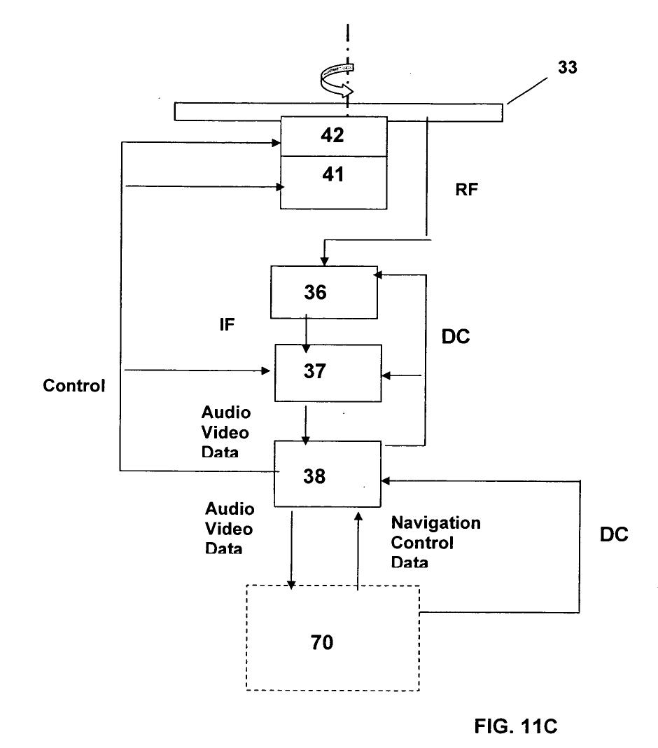

Flow charts describing the functionality of the described above variants of the apparatus according with the embodiment of the invention are shown in FIGS. 11A-11C.

The functionality of the FESA antenna is shown on FIG. 11A. The antenna beam is steered electronically using the phase controlling devices 5, controlled by the interface and control unit 8. The received by antenna layer 3 signal is downconverted by the integrated downconverter 6 and then transferred to the receiver, which in one exemplary embodiment may be integrated in the antenna 7.

The audio/video or data signals at the receiver output are transferred to the multi-media equipment installed in the vehicle through the interface and control unit 8, connected to the multi-media equipment in the vehicle 70 by cable or wireless connection. The navigation and controlled data provided by the user remote control and the navigation equipment in the vehicle are supplied to the interface and control unit in the antenna 8 and processed accordingly to control the integrated receiver 7 and phase controlling devices 5 in order to point the beam toward the selected satellite and to select required data channel. The vehicle power system is used to provide DC supply.

The functionality of the FBMA antenna is shown in FIG. 11B. In this exemplary embodiment, the initially inclined antenna beam is steered mechanically, rotating the antenna layer 13 by means of an azimuth motor 21, which is controlled by the interface and control unit 18, for example, using the navigation data provided by the navigation equipment in the vehicle. The antenna beam is made wide enough to cover the required field of view in elevation.

The received by antenna layer 13 signal is downconverted by the integrated downconverter 16 and then transferred to the receiver, which in one exemplary embodiment may be integrated into antenna 17. The audio/video or data signals at the receiver output are transferred to the multi-media equipment installed in the vehicle through the interface and control unit 18, connected to the said multi-media equipment in the vehicle 70 by cable or wireless connection. A power supply unit installed in the vehicle provides a DC supply.

The functionality of the SEMA antenna is shown in FIG. 11C. The beam is steered mechanically in azimuth in the same manner as in the FBMA antenna, using the azimuth motor 41. In the elevation plane, a steerable beam is generated electronically using phase controlling devices 42. Since the electronic scanning is applied only in one plane, it is convenient to group antenna elements in rows perpendicularly to the plane of scanning and to control the phase of the entire row. This may reduce the number of PCDs used and receptively, to reduce cost and complexity of the antenna in comparison with full electronically steered version FESA.

From another side the elevation beam, generated in the SEMA antenna, may improve significantly the performance of the antenna compared with the FBMA version. The interface and control unit 38, using the information supplied by the vehicle navigation system, provides the beam control. The signal received by antenna layer 33 signal is downconverted by the integrated downconverter 36 and then transferred to the receiver 37, which in one exemplary embodiment may be integrated into antenna.

The audio/video or data signals at the receiver output are transferred to the multi-media equipment installed in the vehicle through the interface and control unit 38, connected to the multi-media equipment in the vehicle 70 by cable or wireless connection. A power supply unit installed in the vehicle provides a DC supply.

Accordingly, the present invention includes using substantially the full power of the transponder of a satellite with a lower bit rate, for example, 1-4 Mbps, and preferably 1-2 Mbps, associated with between one and six video channels, wherein more power is provided per channel, allowing easier reception by small aperture antennas, such as a low profile antenna, used on or in the moving vehicles.

Although exemplary embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

1. A method for providing satellite television and other data to moving vehicles using dedicated transponders, comprising:
using substantially the full power of a transponder of a satellite to provide low-bit rate data to a terminal on or in moving vehicles, wherein
source encoding and transmission of signals carrying the data incorporate digital compression techniques, the transponders each accommodating up to six channels.

2. The method of claim 1, wherein the low-bit rate is in a range of 1-4 Mbps.

3. The method of claim 1, wherein the satellite is an inclined-orbit satellite.

4. The method of claim 1, wherein the encoding uses an efficient compression standard including one of MPEG-2, MPEG-4 , or Microsoft Windows Media 9.

5. The method of claim 1, further comprising using a DVB standard for the transmission of the signals, with QPSK.

6. The method of claim 5, wherein the DVB standard is DVB-S2.

7. The method of claim 1, wherein after encoding, the signals are spread across a frequency band by spread spectrum techniques prior to the transmission of the signals.

8. The method of claim 1, wherein a low bit error rate of the signals is 2 Mbps or less.

9. The method of claim 1, wherein the dedicated transponders are operable in at least one of Ku and Ka bands.

10. The method of claim 1, wherein the terminal is a low-profile antenna.

11. The method of claim 1, wherein the terminal is one of a FESA, FBMA, or SEMA antenna.

12. An apparatus for providing satellite television and other data to a moving vehicle using a dedicated service, comprising:
a terminal having an antenna with an array area less than about 1600 cm² for receiving data from a satellite; and
a receiver, which includes demodulation and signal processing functionality operative to despread a received signal which is less than 5 Mbps and an interface with multi-media equipment installed in the moving vehicle.

13. The apparatus according to claim 12, wherein the terminal comprises one of a FESA, FBMA, or SEMA antenna.

14. The apparatus according to claim 12, wherein the terminal comprises a low profile antenna.

15. The apparatus according to claim 12, wherein the terminal is sized less than about 40 cm in length, with a thickness less than about 4 cm.

16. The apparatus according to clam 13, wherein the FESA antenna comprises phase controlling devices, integrated in a flat antenna in order to steer an antenna beam in all directions electronically.

17. The apparatus according to claim 13, wherein the FBMA antenna incorporates beam pointing using an initially tilted beam in elevation, and wide enough in elevation in order to cover an entire required field of view in elevation and which is steered mechanically in all azimuth directions.

18. The apparatus according to claim 13, wherein the SEMA antenna comprises phase controlling devices to generate a steerable beam in an elevation plane, covering a required field of view and mechanical steering in all azimuth directions.

19. The apparatus according to claim 12, further comprising an LNB, and an interface and control circuit.

20. The apparatus according to claim 19, further comprising an integrated receiver/decoder.

21. The apparatus according to claim 12, wherein information provided from at least one of a navigation system of the vehicle and a dedicated GPS is used to point the antenna beam toward a selected satellite position while the vehicle is moving.

22. The apparatus according to claim 12, wherein the receiver includes a standard DVB-S2 chip set or another efficient compression standard decoder.

23. The apparatus according to claim 22, wherein the decoder is an integrated MPEG-4 decoder.

24. The apparatus according to claim 12, wherein the receiver includes a spread spectrum processor.

25. A satellite system for providing digital video and other data to moving vehicles using dedicated service provided by satellite, comprising:
an uplink terminal for receiving digital video or data signals from plural sources and comprising a combiner for combining said digital video or data signals, a modulator for spreading said data signals over a spectrum comprising substantially all of a satellite transponder capacity and a transmitter for transmitting said spread data signals to the satellite.

26. A satellite system for providing digital video and other data to moving vehicles using dedicated service provided by satellite, comprising:
a small aperture terminal having (1) an antenna with an array area less than about 1600 cm² for receiving data at a bit rate less than 5 Mbps from a satellite; and (2) a receiver, which includes demodulation and signal processing functionality operative to despread a received signal at less than 5 Mbps and an interface with multi-media equipment installed in the moving vehicle.

27. The satellite system according to claim 25, further comprising:
an inclined orbit satellite that is adapted to receive the transmitted spread data signals on an uplink and provide said spread data signals to a small aperture terminal.

28. The satellite system according to claim 26, further comprising:
an inclined orbit satellite that is adapted to receive transmitted spread data signals on an uplink and provide said spread data signals to the small aperture terminal.
